(19) United States
(12) Patent Application Publication
(10) Pub. No.: US 2023/0332315 A1
(43) Pub. Date: Oct. 19, 2023

(54) SYSTEM AND METHOD FOR CONTROLLING PRODUCTION, STORAGE, AND/OR DISTRIBUTION OF HYDROGEN

(71) Applicant: Ohmium International, Inc., Incline Village, NV (US)

(72) Inventors: Chockkalingam Karuppaiah, Incline Village, NV (US); Arne Ballantine, Lugano (CH)

(21) Appl. No.: 18/135,431

(22) Filed: Apr. 17, 2023

Related U.S. Application Data
(60) Provisional application No. 63/332,157, filed on Apr. 18, 2022.

(51) Int. Cl. C25B 15/023; C25B 1/04; C25B 15/08; G06Q 30/0283

(52) U.S. Cl. CPC C25B 15/023; C25B 1/04; C25B 15/08; G06Q 30/0283

(57) ABSTRACT

Systems and techniques are described herein for producing hydrogen. For instance, a method for producing hydrogen is provided. The method may include obtaining a current cost of power; obtaining historical power-cost data indicative of historical costs of power; determining a predicted cost of power based on the historical power-cost data; obtaining a request for hydrogen; determining a current value of hydrogen based on the request for hydrogen; obtaining historical hydrogen-value data indicative of historical values of hydrogen; determining a predicted value of hydrogen based on the historical hydrogen-value data; determining a rate for an electrolyzer to produce hydrogen based on the current cost of power, the predicted cost of power, the current value of hydrogen, and the predicted value of hydrogen; and controlling operations of the electrolyzer such that the electrolyzer produces hydrogen at substantially the determined rate

### CROSS-REFERENCE TO RELATED APPLICATIONS

This application claims priority to U.S. Provisional Application No. 63/332,157 entitled “LOAD FOLLOWING SYSTEM”, filed Apr. 18, 2022, the entire contents of which are incorporated by reference herein.

### FIELD

The present disclosure relates to systems and methods for controlling production, storage, and/or distribution of hydrogen. For example, some embodiments of the present disclosure relate to controlling production, storage, and/or distribution of hydrogen based on a cost of producing hydrogen and a value of hydrogen.

### BACKGROUND

An electrolyzer is a device that may use electrical power, in the form of direct electrical current (DC), to drive a chemical reaction. In the present disclosure, the term “electrolyzer” may refer to a device that may produce hydrogen by applying a DC current to water to separate hydrogen from oxygen.

An electrolyzer may receive electrical power, in the form of alternating electrical current (AC), from a power grid. A power provider (e.g., a “utility”) may provide the electrical power and may charge an operator of the electrolyzer for electrical power consumed by the electrolyzer. Additionally, the operator of the electrolyzer may purchase water to be used by the electrolyzer. The operator of the electrolyzer may sell hydrogen to consumers.

### BRIEF SUMMARY

The following presents a simplified summary relating to one or more embodiments disclosed herein. Thus, the following summary should not be considered an extensive overview relating to all contemplated embodiments, nor should the following summary be considered to identify key or critical elements relating to all contemplated embodiments or to delineate the scope associated with any particular embodiment. Accordingly, the following summary presents certain concepts relating to one or more embodiments relating to the mechanisms disclosed herein in a simplified form to precede the detailed description presented below.

Systems and techniques are described for producing hydrogen. According to at least one example, a method is provided for producing hydrogen. The method includes: obtaining a current cost of power; obtaining historical power-cost data indicative of historical costs of power; determining a predicted cost of power based on the historical power-cost data; obtaining a request for hydrogen; determining a current value of hydrogen based on the request for hydrogen; obtaining historical hydrogen-value data indicative of historical values of hydrogen; determining a predicted value of hydrogen based on the historical hydrogen-value data; determining a rate for an electrolyzer to produce hydrogen based on the current cost of power, the predicted cost of power, the current value of hydrogen, and the predicted value of hydrogen; and controlling operations of the electrolyzer such that the electrolyzer produces hydrogen at substantially the determined rate.

In another example, an apparatus for producing hydrogen is provided that includes at least one memory and at least one processor (e.g., configured in circuitry) coupled to the at least one memory. The at least one processor configured to: obtain a current cost of power; obtain historical power-cost data indicative of historical costs of power; determine a predicted cost of power based on the historical power-cost data; obtain a request for hydrogen; determine a current value of hydrogen based on the request for hydrogen; obtain historical hydrogen-value data indicative of historical values of hydrogen; determine a predicted value of hydrogen based on the historical hydrogen-value data; determine a rate for an electrolyzer to produce hydrogen based on the current cost of power, the predicted cost of power, the current value of hydrogen, and the predicted value of hydrogen; and control operations of the electrolyzer such that the electrolyzer produces hydrogen at substantially the determined rate.

In another example, a non-transitory computer-readable medium is provided that has stored thereon instructions that, when executed by one or more processors, cause the one or more processors to: obtain a current cost of power; obtain historical power-cost data indicative of historical costs of power; determine a predicted cost of power based on the historical power-cost data; obtain a request for hydrogen; determine a current value of hydrogen based on the request for hydrogen; obtain historical hydrogen-value data indicative of historical values of hydrogen; determine a predicted value of hydrogen based on the historical hydrogen-value data; determine a rate for an electrolyzer to produce hydrogen based on the current cost of power, the predicted cost of power, the current value of hydrogen, and the predicted value of hydrogen; and control operations of the electrolyzer such that the electrolyzer produces hydrogen at substantially the determined rate.

In another example, an apparatus for producing hydrogen is provided. The apparatus includes: means for obtaining a current cost of power; means for obtaining historical power-cost data indicative of historical costs of power; means for determining a predicted cost of power based on the historical power-cost data; means for obtaining a request for hydrogen; means for determining a current value of hydrogen based on the request for hydrogen; means for obtaining historical hydrogen-value data indicative of historical values of hydrogen; means for determining a predicted value of hydrogen based on the historical hydrogen-value data; means for determining a rate for an electrolyzer to produce hydrogen based on the current cost of power, the predicted cost of power, the current value of hydrogen, and the predicted value of hydrogen; and means for controlling operations of the electrolyzer such that the electrolyzer produces hydrogen at substantially the determined rate.

In another example, a system for producing hydrogen is provided. The system includes: one or more electrolyzers configured to receive power and to produce hydrogen; and a controller configured to: obtain a current cost of power; obtain historical power-cost data indicative of historical costs of power; determine a predicted cost of power based on the historical power-cost data; obtain a request for hydrogen; determine a current value of hydrogen based on the request for hydrogen; obtain historical hydrogen-value data indicative of historical values of hydrogen; determine a predicted value of hydrogen based on the historical hydrogen-value data; determine a rate for an electrolyzer to produce hydrogen based on the current cost of power, the predicted cost of power, the current value of hydrogen, and the predicted value of hydrogen; and control operations of the electrolyzer such that the electrolyzer produces hydrogen at substantially the determined rate.

In another example, a method is provided for producing hydrogen. The method includes: obtaining a current cost of power; obtaining a predicted cost of power; obtaining a current value of hydrogen; obtaining a predicted value of hydrogen; determining a rate for an electrolyzer to produce hydrogen based on the current cost of power, the predicted cost of power, the current value of hydrogen, and the predicted value of hydrogen; controlling operations of the electrolyzer such that the electrolyzer produces hydrogen at substantially the determined rate; determining to store a first amount of hydrogen based on the current cost of power, the predicted cost of power, the current value of hydrogen, and the predicted value of hydrogen; directing the first amount of hydrogen to a hydrogen storage; determining to remove a second amount of hydrogen from the hydrogen storage based on the current cost of power, the predicted cost of power, the current value of hydrogen, and/or the predicted value of hydrogen; and directing the second amount of hydrogen from the hydrogen storage.

In another example, an apparatus for producing hydrogen is provided that includes at least one memory and at least one processor (e.g., configured in circuitry) coupled to the at least one memory. The at least one processor configured to: obtain a current cost of power; obtain a predicted cost of power; obtain a current value of hydrogen; obtain a predicted value of hydrogen; determine a rate for an electrolyzer to produce hydrogen based on the current cost of power, the predicted cost of power, the current value of hydrogen, and the predicted value of hydrogen; control operations of the electrolyzer such that the electrolyzer produces hydrogen at substantially the determined rate; determine to store a first amount of hydrogen based on the current cost of power, the predicted cost of power, the current value of hydrogen, and the predicted value of hydrogen; direct the first amount of hydrogen to a hydrogen storage; determine to remove a second amount of hydrogen from the hydrogen storage based on the current cost of power, the predicted cost of power, the current value of hydrogen, and/or the predicted value of hydrogen; and direct the second amount of hydrogen from the hydrogen storage. In another example, a non-transitory computer-readable medium is provided that has stored thereon instructions that, when executed by one or more processors, cause the one or more processors to: obtain a current cost of power; obtain a predicted cost of power; obtain a current value of hydrogen; obtain a predicted value of hydrogen; determine a rate for an electrolyzer to produce hydrogen based on the current cost of power, the predicted cost of power, the current value of hydrogen, and the predicted value of hydrogen; control operations of the electrolyzer such that the electrolyzer produces hydrogen at substantially the determined rate; determine to store a first amount of hydrogen based on the current cost of power, the predicted cost of power, the current value of hydrogen, and the predicted value of hydrogen; direct the first amount of hydrogen to a hydrogen storage; determine to remove a second amount of hydrogen from the hydrogen storage based on the current cost of power, the predicted cost of power, the current value of hydrogen, and/or the predicted value of hydrogen; and direct the second amount of hydrogen from the hydrogen storage.

In another example, an apparatus for producing hydrogen is provided. The apparatus includes: means for obtaining a current cost of power; means for obtaining a predicted cost of power; means for obtaining a current value of hydrogen; means for obtaining a predicted value of hydrogen; means for determining a rate for an electrolyzer to produce hydrogen based on the current cost of power, the predicted cost of power, the current value of hydrogen, and the predicted value of hydrogen; means for controlling operations of the electrolyzer such that the electrolyzer produces hydrogen at substantially the determined rate; means for determining to store a first amount of hydrogen based on the current cost of power, the predicted cost of power, the current value of hydrogen, and the predicted value of hydrogen; means for directing the first amount of hydrogen to a hydrogen storage; means for determining to remove a second amount of hydrogen from the hydrogen storage based on the current cost of power, the predicted cost of power, the current value of hydrogen, and/or the predicted value of hydrogen; and means for directing the second amount of hydrogen from the hydrogen storage.

In another example, a system for producing hydrogen is provided. The system includes: one or more electrolyzers configured to receive power and to produce hydrogen; and a controller configured to: obtain a current cost of power; obtain a predicted cost of power; obtain a current value of hydrogen; obtain a predicted value of hydrogen; determine a rate for an electrolyzer to produce hydrogen based on the current cost of power, the predicted cost of power, the current value of hydrogen, and the predicted value of hydrogen; control operations of the electrolyzer such that the electrolyzer produces hydrogen at substantially the determined rate; determine to store a first amount of hydrogen based on the current cost of power, the predicted cost of power, the current value of hydrogen, and the predicted value of hydrogen; direct the first amount of hydrogen to a hydrogen storage; determine to remove a second amount of hydrogen from the hydrogen storage based on the current cost of power, the predicted cost of power, the current value of hydrogen, and/or the predicted value of hydrogen; and direct the second amount of hydrogen from the hydrogen storage.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating a system for controlling production, storage, and/or distribution of hydrogen based on a cost producing hydrogen and/or a value of hydrogen, according to various embodiments of the present disclosure.

FIG. 2 is a block diagram illustrating an electrolyzer which may produce hydrogen, according to various embodiments of the present disclosure.

FIG. 3 is a block diagram illustrating a system for producing, storing, and distributing hydrogen, according to various embodiments of the present disclosure.

FIG. 4 illustrates an example of a process for controlling production, storage, and/or distribution of hydrogen based on cost and/or value, according to various embodiments of the present disclosure.

FIG. 5 illustrates an example of a process for controlling production, storage, and/or distribution of hydrogen based on cost and/or value, according to various embodiments of the present disclosure.

FIG. 6 illustrates an example computing-device architecture of an example computing device which can implement the various techniques described herein.

### DETAILED DESCRIPTION

The cost of power may vary over time. For example, at some times (e.g., during times of low demand, such as at night) the cost of power may be lower than at other times (e.g., during times of high demand, such as during the day). The cost of power may follow daily and/or seasonal trends. Also, the cost of water may also vary (e.g., seasonally).

The electrolyzer may provide hydrogen to consumers through a pipeline and/or in storage tanks. Consumers may be willing to pay varying amounts for hydrogen at different times, thus, the value of hydrogen may change over time. In the present disclosure, the terms “cost” and “value” may be considered from the perspective of the operator of the electrolyzer. For example, the term “cost” may refer to costs to the operator of the electrolyzer to produce hydrogen and the term “value” may refer to the price for which hydrogen can be sold to a consumer.

The present disclosure describes systems, apparatuses, methods (also referred to herein as processes), and computer-readable media (collectively referred to as “systems and techniques”) for controlling production, storage, and/or distribution of hydrogen based on a cost of producing hydrogen and a value of hydrogen. For example, the systems and techniques may determine a rate at which to produce hydrogen (using one or more electrolyzers) based on one or more of the cost of power, the cost of water, and/or the value of hydrogen. For example, the systems and techniques may determine, at a given time, by how much the value of producing hydrogen exceeds the cost of producing hydrogen (e.g., by how much the value of hydrogen exceeds the cost of power and the cost of water). Further, the systems and techniques may determine a rate at which to produce hydrogen based on by how much the value of producing hydrogen exceeds the cost of producing hydrogen.

Further, hydrogen can be produced and stored in hydrogen storage at one time and provided to consumers at a later time. The systems and techniques may take this into account and determine a rate at which to produce hydrogen based on a predicted value of hydrogen, and/or a predicted cost of power. Further, the systems and techniques may determine to store an amount of hydrogen to be provided at a future time. For example, the systems and techniques may obtain a current cost of power and a current value of hydrogen. The systems and techniques may determine a predicted cost of power and a predicted value of hydrogen. The systems and techniques may determine an amount of hydrogen to store in a hydrogen storage to be provided at a future time (e.g., based on the current cost of power being lower than the predicted cost of power and/or based on the current value of hydrogen being lower than the predicted value of hydrogen). Additionally, or alternatively, the systems and techniques may determine when to provide hydrogen from a hydrogen storage (e.g., as a substitute for on in addition to hydrogen being produced by the electrolyzer). As an example, the systems and techniques may determine to provide consumers with hydrogen from a hydrogen storage rather than, or in addition to, hydrogen being currently produced based on current request for hydrogen exceeding a capacity of the electrolyzer, based on a current cost of producing hydrogen exceeding a current value of hydrogen, and/or to service a priority request for hydrogen.

Various aspects of the systems and techniques are described herein and will be discussed below with respect to the figures.

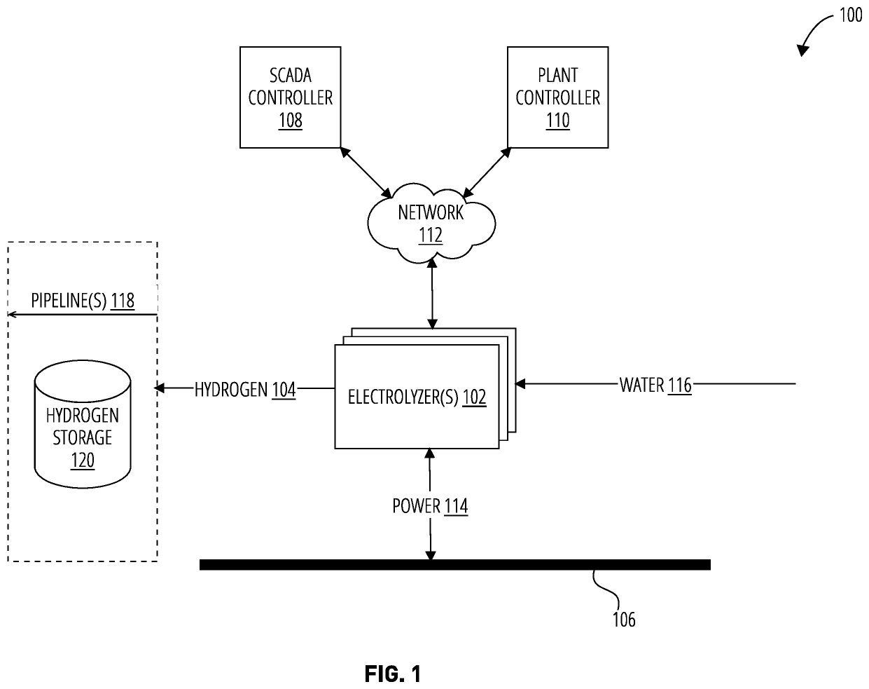

FIG. 1 is a block diagram illustrating a system 100 for controlling production, storage, and/or distribution of hydrogen 104 based on a cost producing hydrogen 104 and/or a value of hydrogen 104, according to various embodiments of the present disclosure. System 100 may be a hydrogen-production installation including one or more electrolyzer(s) 102.

System 100 includes supervisory control and data (SCADA) controller 108. SCADA controller 108 may monitor and control operations within system 100 (e.g., start up, shut down, restart of electrolyzer(s) 102).

System 100 includes plant controller 110, which may receive commands (e.g., from an operator) and control operations within system 100 responsive to the commands. Plant controller 110 may coordinate the operation electrolyzer(s) 102 to cause commands to be executed appropriately. Control loops of plant controller 110 could be open-loop or closed-loop. For the closed-loop controls, plant controller 110 may continuously monitor feedback signals and adjust commands sent to the electrolyzer(s) 102 accordingly.

System 100 may include network 112, which may be any suitable network (e.g., an Ethernet network) for communicatively connecting SCADA controller 108, plant controller 110, and electrolyzer(s) 102.

Electrolyzer(s) 102 may be connected to a power grid at grid connection 106. Grid connection 106 may be, or may include, an electrical distribution system. The power grid may be, for example, a regional, municipal, or private power grid. Grid connection 106 may be included in the hydrogen-production installation or grid connection 106 may be, at least partially, external to the hydrogen-production installation.

Electrolyzer(s) 102 may be, or may include, any suitable electrolyzers, such as, for example, one or more proton exchange membrane (PEM) electrolyzers, one or more alkaline electrolyzers, solid-oxide electrolyzers, and/or one or more anion exchange membrane (AEM) electrolyzers. Electrolyzer(s) 102 may receive electrical power 114 (e.g., AC current) from grid connection 106 and water 116 from a water provider and may produce hydrogen 104.

Hydrogen 104 produced at electrolyzer(s) 102 may be output to, as examples, one or more compressors, hydrogen storage 120 (which may include one or more hydrogen storage tanks), and/or one or more pipeline(s) 118. Production of hydrogen 104 by system 100 may, or may not, be directly tied to demand. For example, system 100 may vary a rate at which hydrogen 104 is produced by electrolyzer(s) 102 independent of a rate at which hydrogen 104 is consumed. Thus, unlike utilities, which may generate electricity according to demand, system 100 may determine a rate at which to produce hydrogen 104 based on factors other than demand (e.g., based on costs and/or values). For example, system 100 may cause electrolyzer(s) 102 to produce hydrogen 104 and provide hydrogen 104 to consumers via pipeline(s) 118 for immediate consumption. Additionally, or alternatively, system 100 may cause electrolyzer(s) 102 to produce hydrogen 104 and to store hydrogen 104 in hydrogen storage 120. At a later time, system 100 may cause hydrogen 104 to be removed from hydrogen storage 120 to be provided to consumers or hydrogen storage 120 may be sold to consumers.

Electrolyzer(s) 102 may produce hydrogen 104 at a number of different rates. The rate at which electrolyzer(s) 102 produce hydrogen 104 may govern an amount of electrical power 114 electrolyzer(s) 102 consume.

System 100 (e.g., using SCADA controller 108 and/or plant controller 110) may control production of hydrogen 104 by electrolyzer(s)s 102 based on costs and/or values, including a cost of power, a cost of water, and a value of hydrogen. Further, system 100 (e.g., using SCADA controller 108 and/or plant controller 110) may control storage of hydrogen 104 at hydrogen storage 120 and/or the distribution of hydrogen 104 via pipeline(s) 118 and/or from hydrogen storage 120 based on the costs and/or values.

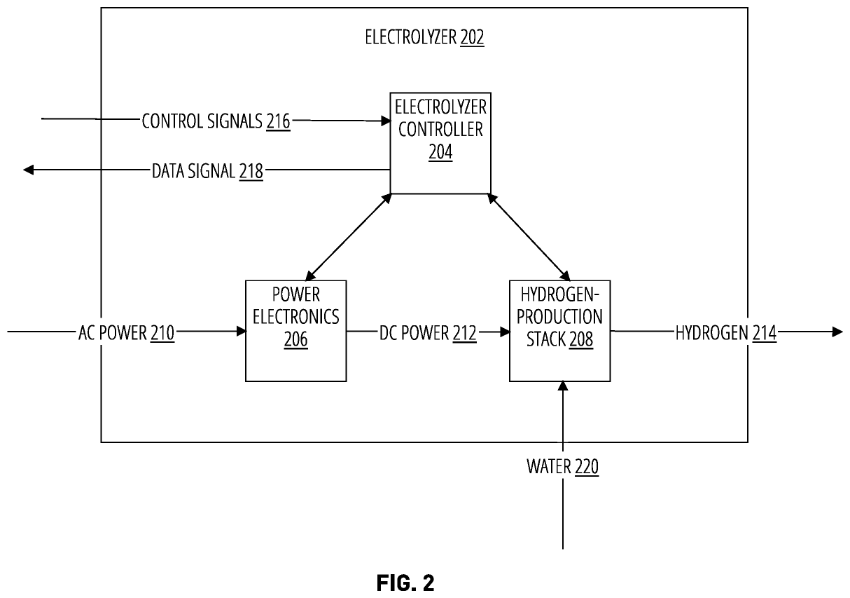

FIG. 2 is a block diagram illustrating an electrolyzer 202 which may produce hydrogen, according to various embodiments of the present disclosure. Electrolyzer 202 may be an example of one of electrolyzer(s) 102 of FIG. 1. Electrolyzer 202 may include an electrolyzer controller 204, power electronics 206, and a hydrogen-production stack 208.

Power electronics 206 may receive AC power 210, e.g., from a power grid, (e.g., at a grid connection such as, grid connection 106 of FIG. 1). Power electronics 206 may include a pulse-width modifier (PWM) and a rectifier to convert AC power 210 to DC power 212. Power electronics 206 may additionally include a DC-DC converter to adjust DC power 212.

Hydrogen-production stack 208 may include one or more units for performing electrolysis, e.g., for using DC power 212 to drive a chemical reaction to produce hydrogen 214 from water 220. Hydrogen-production stack 208 may be, or may include, a proton exchange membrane (PEM) electrolyzer, an alkaline electrolyzer, a solid-oxide electrolyzer, and/or an anion exchange membrane (AEM) electrolyzer. Hydrogen-production stack 208 may be able to produce hydrogen 214 at varying rates. A rate at which hydrogen-production stack 208 produces hydrogen 214 may determine an amount of DC power 212 consumed and an amount of water 220 consumed.

Electrolyzer controllers 204 may control operation hydrogen-production operations of power electronics 206 and/or hydrogen-production stack 208 to control production of hydrogen. For example, responsive to control signals 216 (which control signals 216 may be received from a controller (such as, for example, SCADA controller 108 of FIG. 1 or plant controller 110 of FIG. 1), electrolyzer controller 204 may control operation of power electronics 206 and/or hydrogen-production stack 208. Electrolyzer controller 204 may control operation of power electronics 206 and/or hydrogen-production stack 208 according to one or more electrolyzer-level operational criteria including, e.g., based on an amount of DC power 212 hydrogen-production stack 208 consumes, or based on an amount of hydrogen 214 hydrogen-production stack 208 generates. Electrolyzer controller 204 may provide data signal 218 to the controller.

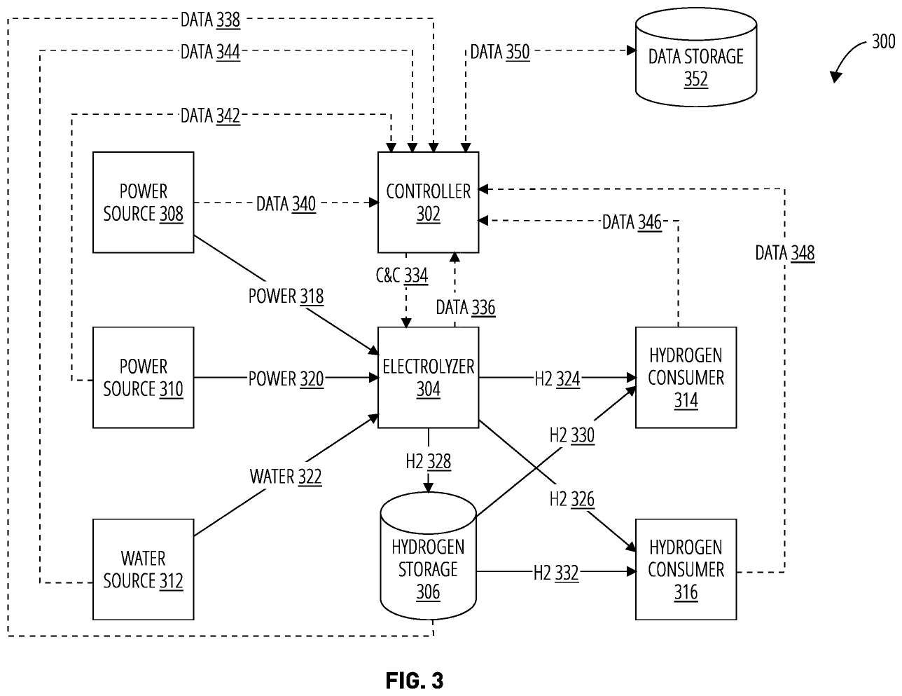

FIG. 3 is a block diagram illustrating a system 300 for producing, storing, and distributing hydrogen, according to various embodiments of the present disclosure. System 300 includes a controller 302 that may control production of hydrogen (which may be alternatively referred to as “H₂”) (e.g., hydrogen 324, hydrogen 326, and hydrogen 328) at an electrolyzer 304. Further, controller 302 may control storage of hydrogen (e.g., hydrogen 328) at hydrogen storage 306 and distribution of hydrogen (e.g., hydrogen 330 and hydrogen 332) from hydrogen storage 306. System 300 may include a hydrogen-production installation.

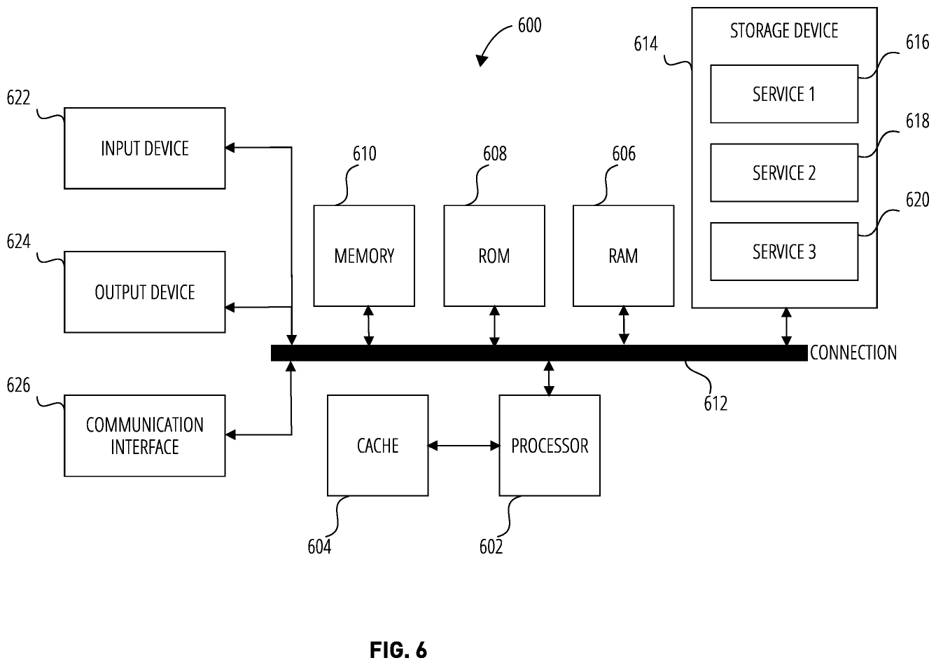

Controller 302 may be, or may include, any suitable computing system configured to control hydrogen production, storage, and distribution. Controller 302 may be implemented as one or more instances of computing-device architecture 600 of FIG. 6. Controller 302 may be implemented in SCADA controller 108 of FIG. 1 and/or plant controller 110 of FIG. 1. Controller 302 may be located at a hydrogen-production installation or located remote from the hydrogen-production installation. In some cases, controller 302 may be implemented in the Cloud and/or as a service.

Electrolyzer 304 may be, or may include, any suitable electrolyzer, such as a proton exchange membrane (PEM) electrolyzer, an alkaline electrolyzer, a solid-oxide electrolyzer, and/or an anion exchange membrane (AEM) electrolyzer. Although electrolyzer 304 is illustrated as a single block and referred to in the singular, system 300 may include any number of electrolyzers.

Hydrogen storage 306 may be, or may include, any suitable means for storing hydrogen, such as one or more stationary hydrogen-storage tanks, or one or more mobile hydrogen-storage tanks (e.g., suitable for transportation by truck, train, or boat). Although hydrogen storage 306 is illustrated as a single block and referred to in the singular, system 300 may include any number of storage tanks.

Power source 308 and power source 310 may be, or may include, any suitable source of power (e.g., power 318 and power 320), such as a power producing entity (e.g., a utility) providing power via a power grid or a power generator or power storage located close to or at the hydrogen-production installation. In some cases, power source 308 may generate power 318 and/or power source 310 may generate power 320 using renewable sources, such as solar energy, wind energy, or geothermal energy. In other cases, power source 308 may generate power 318 and/or power source 310 may generate power 320 using non-renewable sources, such as coal or natural gas.

Power source 308 and power source 310 may be separate and/or independent sources of power for system 300 (even if power source 308 and power source 310 may provide power through the same distribution system). Further, although two power sources are illustrated in FIG. 3, system 300 may receive power from any number of separate and/or independent power sources. Power source 308 may provide power 318 at a first cost of power and power source 310 may provide power 320 at a second cost of power. The first cost of power may be different from the second cost of power. The cost of power may be, or may include, a cost in terms of dollars per watts per hour and/or additional cost factors. For example, there may be benefits to using power produced using renewable energy sources. For example, hydrogen produced using renewable energy sources may have tax or other benefits. Thus, there may be an additional cost factor associated with using power from non-renewable sources. The additional cost factor may, or may not, be directly relatable to the cost in terms of dollars per watt per hour.

Water source 312 may be any suitable source of water 322. Water 322 may be purified before being used in electrolyzer 304, either by water source 312 or within system 300 (e.g, at a water-purification element not illustrated in FIG. 3). In some cases, the cost of purifying water 322 may be factored into the cost of water 322.

Hydrogen consumer 314 and hydrogen consumer 316 may be, or may include, any suitable consumer of hydrogen, such as industrial consumers (e.g., ammonia plants or other chemical processing plants), producers of chargers of fuel cells, or refueling stations. In some cases, hydrogen consumer 314 and/or hydrogen consumer 316 may receive and/or consume hydrogen provided directly, e.g., via a pipeline. In other cases, hydrogen consumer 314 and/or hydrogen consumer 316 may receive hydrogen stored in a storage tank. As such, hydrogen 324 and/or hydrogen 326, provided by electrolyzer 304 to hydrogen consumer 314 and hydrogen consumer 316 respectively, and/or hydrogen 330 and/or hydrogen 332, provided by electrolyzer 304 to hydrogen consumer 314 and hydrogen consumer 316 respectively may be provided through any suitable means such as a pipeline or a storage tank.

Hydrogen consumer 314 and hydrogen consumer 316 may be separate and/or independent consumers of hydrogen. Further, although two hydrogen consumers are illustrated in FIG. 3, system 300 may provide hydrogen to any number of separate and/or independent hydrogen consumers. Hydrogen consumer 314 may purchase (or be willing to purchase) hydrogen at a first price (giving hydrogen provided to hydrogen consumer 314 a first value of hydrogen). Hydrogen consumer 316 may purchase (or be willing to purchase) hydrogen at a second price (giving hydrogen provided to hydrogen consumer 316 a second value of hydrogen). The first value of hydrogen may be different from the second value of hydrogen. In some cases, the value of hydrogen may include the price, in terms of dollars per kilogram and additional value factors. For example, the operator of electrolyzer 304 may have a commitment to provide a certain amount of hydrogen 324 to hydrogen consumer 314 over a certain period of time. There may be benefits or fees associated with the commitment. In such cases, the commitment may be an additional value factor in determining the value of hydrogen. Requests from a consumer that are related to commitments may be referred to as “priority requests” or “mission critical requests.” Such requests may be given priority when determining how much hydrogen to produce at electrolyzer 304 and/or how to distribute and/or store hydrogen.

In general, system 300 may operate as follows. Power source 308 may provide power 318 to electrolyzer 304. Additionally, or alternatively, power source 310 may provide power 320 to electrolyzer 304. Water source 312 may provide water 322 to electrolyzer 304. Electrolyzer 304 may consume water 322 and power 318 and/or power 320 to produce hydrogen 324, hydrogen 326, and/or hydrogen 328. Hydrogen 324 may be provided to hydrogen consumer 314 (either through a pipeline or a storage tank). Hydrogen 326 may be provided to hydrogen consumer 316 (either through a pipeline or in a storage tank). Hydrogen 328 may be stored at hydrogen storage 306. Additionally, or alternatively, hydrogen storage 306 may provide hydrogen 330 to hydrogen consumer 314 (either through a pipeline or in a storage tank) and/or hydrogen storage 306 may provide hydrogen 332 to hydrogen consumer 316 (either through a pipeline or in a storage tank).

Controller 302 may control operation of electrolyzer 304 (e.g., by sending command and control signal 334 to electrolyzer 304). Controller 302 may control how much hydrogen is produced by electrolyzer 304 (or a rate at which electrolyzer 304 produced hydrogen). Further, controller 302 may control where the hydrogen goes after being produced (e.g., the storage and/or distribution of the hydrogen). For example, controller 302 may control how much of the hydrogen produced by electrolyzer 304 is provided to hydrogen consumer 314, how much is provided to hydrogen consumer 316, and how much is stored at hydrogen storage 306. Further, controller 302 may control storage of hydrogen 328 in hydrogen storage 306 and/or distribution of hydrogen 330 and hydrogen 332 from hydrogen storage 306. For example, controller 302 may control how much (or at what rate) hydrogen is distributed from hydrogen storage 306.

Controller 302 may control operations of system 300 (including operations of electrolyzer 304 and/or hydrogen storage 306) based on various data from various sources. For example, controller 302 may receive data 336 from electrolyzer 304 and/or data 338 from hydrogen storage 306 (e.g., operational data). For example, electrolyzer 304 may provide controller 302 with data 336 indicative of hydrogen-production operations at electrolyzer 304 (e.g., how much hydrogen is being produced, additional capacity of electrolyzer 304 to produce additional hydrogen, and/or factors preventing electrolyzer 304 from producing hydrogen). Additionally, or alternatively, hydrogen storage 306 may provide controller 302 with data 338 indicative of storage at hydrogen storage 306 (e.g., how much hydrogen is being stored at hydrogen storage 306 and/or how much additional capacity hydrogen storage 306 has to store additional hydrogen).

Additionally, or alternatively, power source 308 may provide data 340 to controller 302 and/or power source 310 may provide data 342 to controller 302. Data 340 may include cost data, e.g., a current cost of power 318. Data 342 may include cost data, e.g., a current cost of power 320. Similarly, water source 312 may provide data 344 to controller 302. Data 344 may include cost data, e.g., a current cost of water 322.

Additionally, or alternatively, hydrogen consumer 314 may provide data 346 to controller 302 and/or hydrogen consumer 316 may provide data 348 to controller 302. Data 346 may include a request for hydrogen including price data, e.g., a current price at which hydrogen consumer 314 is buying, or is willing to buy, hydrogen (e.g., hydrogen 324 and/or hydrogen 330). Data 346 may additionally include a request for hydrogen in the future, e.g., an indication of an intent to buy hydrogen at a future time based on expected use. The value of hydrogen 324 and/or hydrogen 330 may be based, at least in part, on data 346. Further, data 346 may include use data, e.g., an amount of hydrogen (e.g., hydrogen 324 and/or hydrogen 330) hydrogen consumer 314 is, or has, consumed. Data 348 may include price data, e.g., a current price at which hydrogen consumer 316 is buying, or is willing to buy, hydrogen (e.g., hydrogen 326 and/or hydrogen 332). Data 348 may additionally include a request for hydrogen in the future, e.g., an indication of an intent to buy hydrogen at a future time based on expected use. The value of hydrogen 326 and/or hydrogen 332 may be based, at least in part, on data 348. Further, data 348 may include use data, e.g., an amount of hydrogen (e.g., hydrogen 326 and/or hydrogen 332) hydrogen consumer 316 is, or has, consumed.

Additionally, or alternatively, controller 302 may receive data 350 from a data storage 352, (e.g., from a network-connected computing device or network-connected data storage). Data 350 may be, or may include, historical cost data (e.g., historical costs of power and/or water), historical value data (e.g., historical values of hydrogen), historical request or use data (e.g., historical data regarding requests for hydrogen and/or use of hydrogen by consumers). In some cases, data store data 350 may include predictions regarding costs of power and/or water, values of hydrogen, and/or requests for hydrogen. Further, data 350 may include weather data, including current weather data, historical weather data, and/or predicted weather data. In some cases, controller 302 may provide data to data storage 352, e.g., to update data storage 352 with data from system 300. For example, controller 302 may provide data based on data 336, data 338, data 340, data 342, data 344, data 346, data 348, to data storage 352. Each of command-and-control signal 334, data 336, data 338, data 340, data 342, data 344, data 346, data 348, and data 350 are illustrated in FIG. 1 using dashed lines for illustrative purposes, e.g., to visually distinguish data and signals from power, water, and hydrogen.

Controller 302 may control operations of system 300 (including operations of electrolyzer 304 and/or hydrogen storage 306) based on data 336, data 338, data 340, data 342, data 344, data 346, data 348, and/or data 350. For example, controller 302 may obtain a current cost of power 318 and/or a current cost of power 320 (e.g., based at least in part on data 340 and/or data 342 respectively). Controller 302 may obtain a historical cost of power 318 and/or a historical cost of power 320 (e.g., as included in data 350). Based on the historical cost of power 318 and/or the historical cost of power 320, based on the current cost of power 318 and/or the current cost of power 320, and/or historical, current, and/or predicted weather data, controller 302 may determine a predicted cost of power. In other cases, controller 302 may obtain the predicted cost of power from another source, e.g., in data 350 from data storage 352. Similarly, controller 302 may obtain a current cost of water, a historical cost of water, and a predicted cost of water.

Additionally, controller 302 may obtain a current value of hydrogen 324 and/or hydrogen 330 (e.g., a value of hydrogen provided to hydrogen consumer 314) and/or a current value of hydrogen 326 and/or hydrogen 332 (e.g., a value of hydrogen provided to hydrogen consumer 316). Controller 302 may obtain a historical value of hydrogen (including a historical value of hydrogen provided to hydrogen consumer 314 and/or a historical value of hydrogen provided to hydrogen consumer 316). Based on the historical value of hydrogen and/or the current value of hydrogen, controller 302 may determine a predicted value of hydrogen. In other cases, controller 302 may obtain the predicted value of hydrogen from another source, e.g., in data 350 from data storage 352.

Controller 302 may control operations of system 300 (including operations of electrolyzer 304 and/or hydrogen storage 306) based on the current cost of power, the predicted cost of power, the current cost of water, the predicted cost of water, the current value of hydrogen and/or the predicted value of hydrogen. For example, controller 302 may determine, at a given time, by how much the current value of producing hydrogen exceeds the current cost of producing hydrogen. For example, controller 302 may determine current values of hydrogen one or more respective consumers. For example, hydrogen consumer 314 may be willing to pay a first amount for hydrogen 324 (which may be referred to as a current value of hydrogen 324) and hydrogen consumer 316 may be willing to pay a second amount hydrogen 326 (which may be referred to as a current value of hydrogen 326). Further the controller may determine a current cost of producing hydrogen, which may include the current cost of power (e.g., the cost of power from the power source that is willing to provide power at the lowest cost), the current cost of water 322, and other costs of operation of electrolyzer 304.

Controller 302 may determine the difference between the current values of hydrogen (e.g., the value of hydrogen 324 and the value of hydrogen 326) and the current cost of producing hydrogen. Controller 302 may determine a rate at which to cause electrolyzer 304 to produce hydrogen based on the difference. For example, if hydrogen consumer 314 is willing to pay more for hydrogen 324 than hydrogen consumer 316 is willing to pay for hydrogen 326 and if the current value of hydrogen 324 exceeds the cost of producing hydrogen, controller 302 may cause electrolyzer 304 to produce as much hydrogen 324 as is being requested by hydrogen consumer 314. Further, once the request from hydrogen consumer 314 is satisfied, if the value of hydrogen 326 exceeds the cost of producing hydrogen, controller 302 may cause electrolyzer 304 to produce hydrogen 326 to meet a request of hydrogen consumer 316. Alternatively, if the cost producing hydrogen exceeds the value of hydrogen 324 and the value of hydrogen 326, controller 302 may cause electrolyzer 304 to not produce hydrogen. As another alternative, if the cost of producing hydrogen exceeds the value of hydrogen 324 and hydrogen 326, controller 302 may cause electrolyzer 304 to store all hydrogen 328 produced at hydrogen storage 306 (e.g., based on a predicted value of hydrogen exceeding the current cost to produce hydrogen).

Additionally, or alternatively, controller 302 may determine to produce hydrogen based on a predicted value of hydrogen and/or a predicted cost of power. For example, controller 302 may determine a predicted value of hydrogen and/or a predicted cost of power based on historic data (e.g., historic values of hydrogen and/or historic costs of power). Then controller 302 may determine to produce hydrogen 328 during periods when cost of power 318 (or cost of power 320) is low (e.g. night time) and direct hydrogen 328 to hydrogen storage 306 in anticipation for there being an increase in demand by hydrogen consumer 314 and/or hydrogen consumer 316 (and an accompanying increase in the value of hydrogen) the following day. Additionally, or alternatively, controller 302 may determine to produce hydrogen 328 during periods when the cost of power 318 (or cost of power 320) is lower than the predicted cost of power and direct hydrogen 328 to hydrogen storage 306 in anticipation of there being an increase in the cost of power.

Additionally, or alternatively, an operator of electrolyzer 304 may have a commitment to provide hydrogen 324 to hydrogen consumer 314. Controller 302 may factor the commitment into any determination regarding the production and/or distribution of hydrogen. For example, controller 302 may consider the opportunity cost of not providing hydrogen 324 to hydrogen consumer 314 when considering the value of hydrogen 324. For example, providing hydrogen 324 to hydrogen consumer 314 may be mission critical for hydrogen consumer 314 and there may be a cost to the operator of electrolyzer 304 if hydrogen 324 is not provided. In some cases, based on the commitment, controller 302 may determine to provide hydrogen 324 to hydrogen consumer 314 as committed (e.g., giving priority to a request of hydrogen consumer 314) and then determine what to do with extra hydrogen (or capacity to produce hydrogen). For example, once electrolyzer 304 has produced and provided hydrogen 324 to hydrogen consumer 314, controller 302 may determine if controller 302 can produce any additional hydrogen, then determine whether to provide the additional hydrogen to hydrogen consumer 316 or to store it at hydrogen storage 306. Additionally, or alternatively, controller 302 may cause electrolyzer 304 to produce and store hydrogen 328 at hydrogen storage 306 based on an upcoming commitment and provide hydrogen 330 to hydrogen consumer 314 responsive to the upcoming commitment.

Additionally, or alternatively, controller 302 may determine to provide consumers (e.g., hydrogen consumer 314 and/or hydrogen consumer 316) with hydrogen (e.g., hydrogen 330 and/or hydrogen 332) from hydrogen storage 306 rather than, or in addition to, hydrogen (e.g., hydrogen 324 and/or hydrogen 326) being currently produced. For example, based in a current value of hydrogen to hydrogen consumer 314 (e.g., a spike in demand), controller 302 may determine to provide hydrogen 324 from electrolyzer 304 to hydrogen consumer 314 and to additionally provide hydrogen 330 from hydrogen storage 306 to hydrogen consumer 314.

As another example, based on a current request for hydrogen from hydrogen consumer 314 exceeding a capacity of electrolyzer 304 to produce hydrogen 324, controller 302 may determine to provide hydrogen 324 from electrolyzer 304 to hydrogen consumer 314 and to additionally provide hydrogen 330 from hydrogen storage 306 to hydrogen consumer 314. Such examples may arise due to commitments between an operator of electrolyzer 304 and hydrogen consumer 314, due to shortages of power 318, power 320, and or water 322, and/or due to a maintenance of electrolyzer 304. As another example, based on a current cost of producing hydrogen 324 exceeding a current value of hydrogen 324 to hydrogen consumer 314, controller 302 may determine to provide hydrogen consumer 314 with hydrogen 330 rather than with hydrogen 324. In such cases, controller 302 may expect to be able to refill hydrogen storage 306 with hydrogen 328 when the cost of producing hydrogen has decreased.

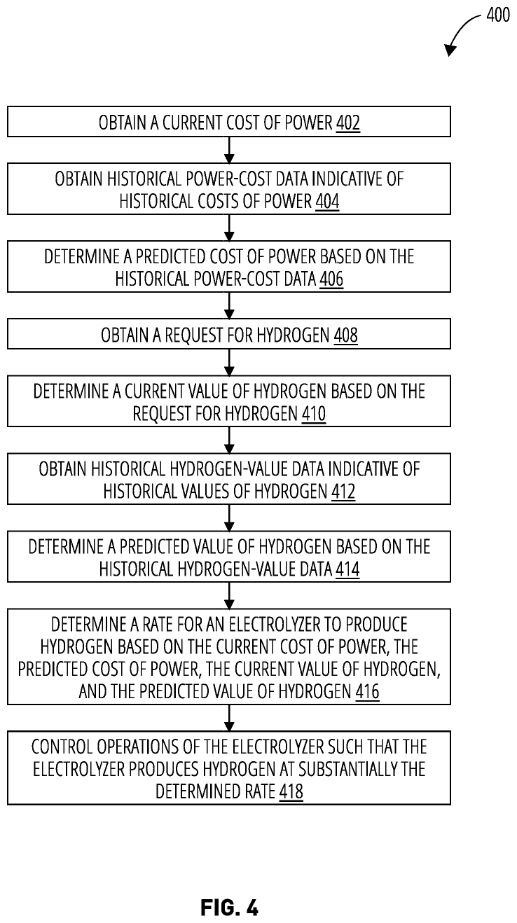

FIG. 4 illustrates an example of a process 400 for controlling production, storage, and/or distribution of hydrogen based on cost and/or value, according to various embodiments of the present disclosure. Process 400, or one or more operations thereof, may be performed by, or at, one or more elements of system 100 of FIG. 1, including, e.g., SCADA controller 108, plant controller 110, and/or electrolyzer(s) 102, at one or more elements of electrolyzer 202, including, e.g., electrolyzer controller 204 and/or at controller 302 of FIG. 3. Additionally, or alternatively, process 400, or one or more operations thereof, may be performed by a computing device (or apparatus) or a component (e.g., a chipset, one or more processors, etc.) of the computing device. One or more of the operations of process 400 may be implemented as software components that are executed and run on one or more compute components or processors (e.g., processor 602 of FIG. 6, or other processor(s)).

At block 402, a computing device (or one or more components thereof) may obtain a current cost of power. For example, controller 302 of FIG. 3 may obtain a current cost of power 318 and/or a current cost of power 320.

In some embodiments, obtaining the current cost of power may include selecting the current cost of power from among two or more costs of power from two or more respective power providers. For example, controller 302 may determine that the less expensive of the cost of power 318 and the cost of power 320 is the current cost of power.

At block 404, the computing device (or one or more components thereof) may obtain historical power-cost data indicative of historical costs of power. For example, controller 302 may obtain historical power-cost data in data 350 from data storage 352.

At block 406, the computing device (or one or more components thereof) may determine a predicted cost of power based on the historical power-cost data. For example, controller 302 may determine a predicted cost of power based on the historical power-cost data and/or based on the current cost of power.

At block 408, the computing device (or one or more components thereof) may obtain a request for hydrogen. For example, controller 302 may receive a request for hydrogen from hydrogen consumer 314 and/or a request for hydrogen from hydrogen consumer 316.

At block 410, the computing device (or one or more components thereof) may determine a current value of hydrogen based on the request for hydrogen. For example, controller 302 may determine a value of hydrogen, e.g., if provided to hydrogen consumer 314 or if provided to hydrogen consumer 316.

At block 412, the computing device (or one or more components thereof) may obtain historical hydrogen-value data indicative of historical values of hydrogen. For example, controller 302 may obtain historical values of hydrogen in data 350 from data storage 352.

At block 414, the computing device (or one or more components thereof) may determine a predicted value of hydrogen based on the historical hydrogen-value data. For example, controller 302 may determine, based on the historical hydrogen value data and/or based on the current value of hydrogen, a predicted value of hydrogen.

At block 416, the computing device (or one or more components thereof) may determine a rate for an electrolyzer to produce hydrogen based on the current cost of power, the predicted cost of power, the current value of hydrogen, and the predicted value of hydrogen. For example, controller 302 may determine a rate at which electrolyzer 304 should produce hydrogen.

At block 418, the computing device (or one or more components thereof) may control operations of the electrolyzer such that the electrolyzer produces hydrogen at substantially the determined rate. For example, controller 302 may control controller 302 to produce hydrogen at the determine rate.

In some embodiments, the computing device (or one or more components thereof) may direct hydrogen to be provided to consumers. For example, controller 302 may direct hydrogen 324 to hydrogen consumer 314 and/or hydrogen 326 to hydrogen consumer 316.

In some embodiments, the computing device (or one or more components thereof) may determine an amount of hydrogen to store based on the current value of hydrogen and the predicted value of hydrogen. For example. Controller 302 may determine an amount of hydrogen 328 to store at hydrogen storage 306. In some embodiments, the computing device (or one or more components thereof) may determine a storage capacity of a hydrogen storage. For example, controller 302 may determine an amount of hydrogen stored at hydrogen storage 306 and/or an amount of storage capacity available at hydrogen storage 306. In some embodiments, the computing device (or one or more components thereof) may direct the amount of hydrogen to a hydrogen storage. For example, controller 302 may direct hydrogen 328 to hydrogen storage 306. In some embodiments, the computing device (or one or more components thereof) may determine an amount of hydrogen to remove from a hydrogen storage based on the current value of hydrogen and the predicted value of hydrogen. For example, controller 302 may determine an amount hydrogen 330 and/or hydrogen 332 to be removed from hydrogen storage 306 (e.g., to be provided to hydrogen consumer 314 and/or hydrogen consumer 316).

In some embodiments, the computing device (or one or more components thereof) may determine an amount of hydrogen to store based on the current cost of power and the predicted cost of power. For example. Controller 302 may determine an amount of hydrogen 328 to store at hydrogen storage 306. In some embodiments, the computing device (or one or more components thereof) may determine a storage capacity of a hydrogen storage. For example, controller 302 may determine an amount of hydrogen stored at hydrogen storage 306 and/or an amount of storage capacity available at hydrogen storage 306. In some embodiments, the computing device (or one or more components thereof) may direct the amount of hydrogen to a hydrogen storage. For example, controller 302 may direct hydrogen 328 to hydrogen storage 306. In some embodiments, the computing device (or one or more components thereof) may determine an amount of hydrogen to remove from a hydrogen storage based on the current cost of power and the predicted cost of power. For example, controller 302 may determine an amount hydrogen 330 and/or hydrogen 332 to be removed from hydrogen storage 306 (e.g., to be provided to hydrogen consumer 314 and/or hydrogen consumer 316).

In some embodiments, the computing device (or one or more components thereof) may obtain a priority request for hydrogen. Determining the rate for the electrolyzer to produce hydrogen (e.g., at block 416) may be further based on the priority request for hydrogen. For example, controller 302 may receive a request for hydrogen 324 from hydrogen consumer 314. The operator of electrolyzer 304 may have a commitment to provide hydrogen 324 to hydrogen consumer 314. Thus, the request from hydrogen consumer 314 for hydrogen 324 may be a priority request. Controller 302 may determine how much hydrogen 324 to produce and/or provide to hydrogen consumer 314 based on the priority request.

In some embodiments, the computing device (or one or more components thereof) may further obtain a current cost of water. Determining the rate for the electrolyzer to produce hydrogen (e.g., at block 416) may be further based on the current cost of water. For example, controller 302 may determine how much hydrogen to produce at electrolyzer 304 based, at least in part, on a cost of water 322.

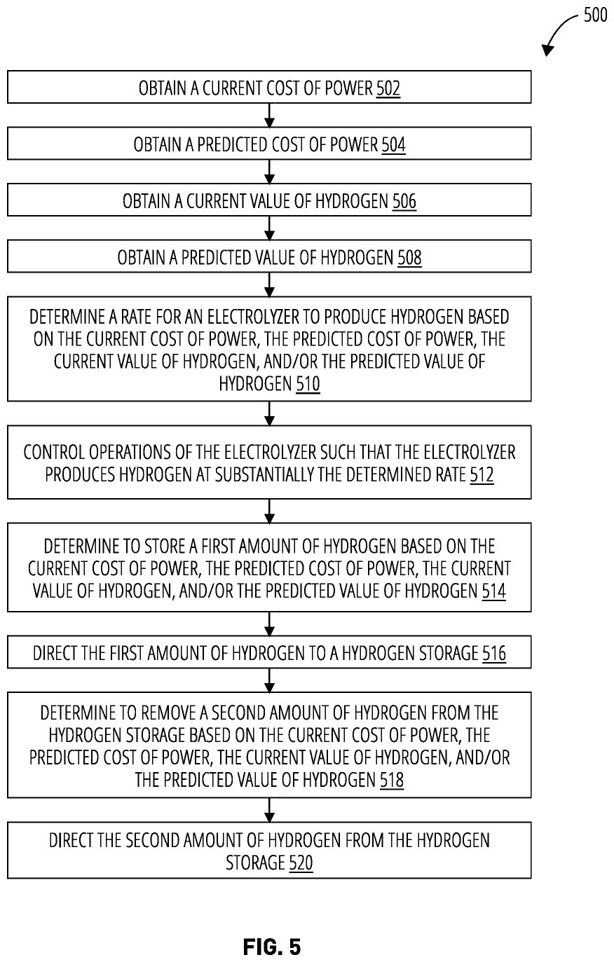

FIG. 5 illustrates an example of a process 500 for controlling production, storage, and/or distribution of hydrogen based on cost and/or value, according to various embodiments of the present disclosure. Process 500, or one or more operations thereof, may be performed by, or at, one or more elements of system 100 of FIG. 1, including, e.g., SCADA controller 108, plant controller 110, and/or electrolyzer(s) 102, and/or at one or more elements of electrolyzer 202, including, e.g., electrolyzer controller 204. Additionally, or alternatively, process 500, or one or more operations thereof, may be performed by a computing device (or apparatus) or a component (e.g., a chipset, one or more processors, etc.) of the computing device. One or more of the operations of process 500 may be implemented as software components that are executed and run on one or more compute components or processors (e.g., processor 602 of FIG. 6, or other processor(s)).

At block 502, a computing device (or one or more components thereof) may obtain a current cost of power. For example, controller 302 of FIG. 3 may obtain a cost of power 318 and/or a cost of power 320.

At block 504, the computing device (or one or more components thereof) may obtain a predicted cost of power. For example, controller 302 may obtain a predicted cost of power from data storage 352. The predicted cost of power may be based on historical power-cost data.

At block 506, the computing device (or one or more components thereof) may obtain a current value of hydrogen. For example, controller 302 may receive requests for hydrogen from hydrogen consumer 314 and/or from hydrogen consumer 316. Controller 302 may determine a value of hydrogen based on the requests.

At block 508, the computing device (or one or more components thereof) may obtain a predicted value of hydrogen. For example, controller 302 may receive a predicted value of hydrogen from data storage 352. The predicted value of hydrogen may be based on historical hydrogen-value data.

At block 510, the computing device (or one or more components thereof) may determine a rate for an electrolyzer to produce hydrogen based on the current cost of power, the predicted cost of power, the current value of hydrogen, and the predicted value of hydrogen. For example, controller 302 may determine a rate for electrolyzer 304 to produce hydrogen based on the current cost of power, the predicted cost of power, the current value of hydrogen, and the predicted value of hydrogen.

At block 512, the computing device (or one or more components thereof) may control operations of the electrolyzer such that the electrolyzer produces hydrogen at substantially the determined rate. For example, controller 302 may control operations of electrolyzer 304 such that electrolyzer 304 produces hydrogen at the determined rate. Further, controller 302 may direct the provision of hydrogen 324 to hydrogen consumer 314 and/or the provision of hydrogen 326 to hydrogen consumer 316.

At block 514, the computing device (or one or more components thereof) may determine to store a first amount of hydrogen based on the current cost of power, the predicted cost of power, the current value of hydrogen, and the predicted value of hydrogen. For example, controller 302 may determine to store hydrogen (e.g., at hydrogen storage 306) based on the current cost of power, the predicted cost of power, the current value of hydrogen, and the predicted value of hydrogen.

At block 516, the computing device (or one or more components thereof) may direct the first amount of hydrogen to a hydrogen storage. For example, controller 302 may direct hydrogen 328 to hydrogen storage 306.

At block 518, the computing device (or one or more components thereof) may determine to remove a second amount of hydrogen from the hydrogen storage based on the current cost of power, the predicted cost of power, the current value of hydrogen, and/or the predicted value of hydrogen. For example, controller 302 may determine an amount of hydrogen to remove from hydrogen storage 306 (e.g., to provide to hydrogen consumer 314 and/or to hydrogen consumer 316).

At block 520, the computing device (or one or more components thereof) may direct the second amount of hydrogen from the hydrogen storage. For example, controller 302 may direct the removal of hydrogen 330 and/or hydrogen 332 from hydrogen storage 306 (e.g., to be provided to hydrogen consumer 314 and/or hydrogen consumer 316).

In some examples, the methods described herein (e.g., process 400 of FIG. 4, process 500 of FIG. 5, and/or other methods described herein) can be performed by a computing device or apparatus. In one example, one or more of the methods can be performed by system 100 of FIG. 1, SCADA controller 108 of FIG. 1, plant controller 110 of FIG. 1, and/or electrolyzer controller 204 of FIG. 2. In another example, one or more of the methods can be performed by one or more elements of computing-device architecture 600 shown in FIG. 6. For instance, a computing device with computing-device architecture 600 shown in FIG. 6 can include the components of the system 100, and/or electrolyzer 202, and can implement the operations of the process 400, process 500, and/or other process described herein.

The computing device can include any suitable device, a desktop computer, a server computer, and/or any other computing device with the resource capabilities to perform the processes described herein, including process 400, process 500, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 400, process 500, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 400, process 500, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 6 illustrates an example computing-device architecture 600 of an example computing device which can implement the various techniques described herein. In some examples, the computing device can include a personal computer, a laptop computer, a server computer, or other device. The components of computing-device architecture 600 are shown in electrical communication with each other using connection 612, such as a bus. The example computing-device architecture 600 includes a processing unit (CPU or processor) 602 and computing device connection 612 that couples various computing device components including computing device memory 610, such as read only memory (ROM) 608 and random-access memory (RAM) 606, to processor 602.

Computing-device architecture 600 can include a cache of high-speed memory connected directly with, in close proximity to, or integrated as part of processor 602. Computing-device architecture 600 can copy data from memory 610 and/or the storage device 614 to cache 604 for quick access by processor 602. In this way, the cache can provide a performance boost that avoids processor 602 delays while waiting for data. These and other modules can control or be configured to control processor 602 to perform various actions. Other computing device memory 610 may be available for use as well. Memory 610 can include multiple different types of memory with different performance characteristics. Processor 602 can include any general-purpose processor and a hardware or software service, such as service 1 616, service 2 618, and service 3 620 stored in storage device 614, configured to control processor 602 as well as a special-purpose processor where software instructions are incorporated into the processor design. Processor 602 may be a self-contained system, containing multiple cores or processors, a bus, memory controller, cache, etc. A multi-core processor may be symmetric or asymmetric.

To enable user interaction with the computing-device architecture 600, input device 622 can represent any number of input mechanisms, such as a microphone for speech, a touch-sensitive screen for gesture or graphical input, keyboard, mouse, motion input, speech and so forth. Output device 624 can also be one or more of a number of output mechanisms known to those of skill in the art, such as a display, projector, television, speaker device, etc. In some instances, multimodal computing devices can enable a user to provide multiple types of input to communicate with computing-device architecture 600. Communication interface 626 can generally govern and manage the user input and computing device output. There is no restriction on operating on any particular hardware arrangement and therefore the basic features here may easily be substituted for improved hardware or firmware arrangements as they are developed.

Storage device 614 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 606, read only memory (ROM) 608, and hybrids thereof. Storage device 614 can include services 616, 618, and 620 for controlling processor 602. Other hardware or software modules are contemplated. Storage device 614 can be connected to the computing device connection 612. In one embodiment, a hardware module that performs a particular function can include the software component stored in a computer-readable medium in connection with the necessary hardware components, such as processor 602, connection 612, output device 624, and so forth, to carry out the function.

Embodiments of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, embodiments of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various embodiments of this disclosure, the term “device” is not limited to a specific configuration, type, or number of objects. Additionally, the term “system” is not limited to multiple components or specific embodiments. For example, a system may be implemented on one or more printed circuit boards or other substrates and may have movable or static components. While the below description and examples use the term “system” to describe various embodiments of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, embodiments of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and embodiments of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative embodiments of the disclosure include:

Embodiment 1. A method for producing hydrogen, the method comprising: obtaining a current cost of power; obtaining historical power-cost data indicative of historical costs of power; determining a predicted cost of power based on the historical power-cost data; obtaining a request for hydrogen; determining a current value of hydrogen based on the request for hydrogen; obtaining historical hydrogen-value data indicative of historical values of hydrogen; determining a predicted value of hydrogen based on the historical hydrogen-value data; determining a rate for an electrolyzer to produce hydrogen based on the current cost of power, the predicted cost of power, the current value of hydrogen, and the predicted value of hydrogen; and controlling operations of the electrolyzer such that the electrolyzer produces hydrogen at substantially the determined rate.

Embodiment 2. The method of embodiment 1, further comprising determining an amount of hydrogen to store based on the current value of hydrogen and the predicted value of hydrogen.

Embodiment 3. The method of embodiment 2, further comprising determining a storage capacity of a hydrogen storage.

Embodiment 4. The method of any one of embodiments 2 or 3, further comprising directing the amount of hydrogen to a hydrogen storage.

Embodiment 5. The method of any one of embodiments 2 to 4, further comprising determining an amount of hydrogen to remove from a hydrogen storage based on the current value of hydrogen and the predicted value of hydrogen.

Embodiment 6. The method of any one of embodiments 2 to 5, further comprising determining an amount of hydrogen to store based on the current cost of power and the predicted cost of power.

Embodiment 7. The method of embodiment 6, further comprising determining a storage capacity of a hydrogen storage.

Embodiment 8. The method of any one of embodiments 6 or 7, further comprising directing the amount of hydrogen to a hydrogen storage.

Embodiment 9. The method of any one of embodiments 1 to 8, further comprising determining an amount of hydrogen to remove from a hydrogen storage based on the current cost of power and the predicted cost of power.

Embodiment 10. The method of any one of embodiments 1 to 9, further comprising obtaining a priority request for hydrogen, wherein determining the rate for the electrolyzer to produce hydrogen is further based on the priority request for hydrogen.

Embodiment 11. The method of any one of embodiments 1 to 10, wherein obtaining the current cost of power comprises selecting the current cost of power from among two or more costs of power from two or more respective power providers.

Embodiment 12. The method of any one of embodiments 1 to 11, further comprising obtaining a current cost of water, wherein determining the rate for the electrolyzer to produce hydrogen is further based on the current cost of water.

Embodiment 13. A method for producing hydrogen, the method comprising: obtaining a current cost of power; obtaining a predicted cost of power; obtaining a current value of hydrogen; obtaining a predicted value of hydrogen; determining a rate for an electrolyzer to produce hydrogen based on the current cost of power, the predicted cost of power, the current value of hydrogen, and the predicted value of hydrogen; controlling operations of the electrolyzer such that the electrolyzer produces hydrogen at substantially the determined rate; determining to store a first amount of hydrogen based on the current cost of power, the predicted cost of power, the current value of hydrogen, and the predicted value of hydrogen; directing the first amount of hydrogen to a hydrogen storage; determining to remove a second amount of hydrogen from the hydrogen storage based on the current cost of power, the predicted cost of power, the current value of hydrogen, and/or the predicted value of hydrogen; and directing the second amount of hydrogen from the hydrogen storage.

Embodiment 14. A system for producing hydrogen, the system comprising: one or more electrolyzers configured to receive power and to produce hydrogen; and a controller configured to: obtain a current cost of the power; obtain historical power-cost data indicative of historical costs of power; determine a predicted cost of power based on the historical power-cost data; obtain a request for hydrogen; determine a current value of hydrogen based on the request for hydrogen; obtain historical hydrogen-value data indicative of historical values of hydrogen; determine a predicted value of hydrogen based on the historical hydrogen-value data; determine a rate for the one or more electrolyzers to produce hydrogen based on the current cost of power, the predicted cost of power, the current value of hydrogen, and the predicted value of hydrogen; and control operations of the one or more electrolyzers such that the one or more electrolyzers produces hydrogen at substantially the determined rate.

Embodiment 15. The system of embodiment 14, wherein the controller is further configured to determine an amount of hydrogen to store based on the current value of hydrogen, the predicted value of hydrogen, the current cost of power, and the predicted cost of power.

Embodiment 16. The system of embodiment 15, wherein the controller is further configured to determine a storage capacity of a hydrogen storage.

Embodiment 17. The system of any one of embodiments 14 to 16, wherein the controller is further configured to direct the amount of hydrogen to a hydrogen storage.

Embodiment 18. The system of any one of embodiments 15 to 17, wherein the controller is further configured to determine an amount of hydrogen to remove from a hydrogen storage based on the current value of hydrogen and the predicted value of hydrogen.

Embodiment 19. The system of any one of embodiments 14 to 18, wherein the controller is further configured to obtain a priority request for hydrogen and wherein the controller is further configured to determine the rate for the electrolyzer to produce hydrogen further based on the priority request for hydrogen.

Embodiment 20. The system of any one of embodiments 14 to 19, wherein the controller is further configured to obtain the current cost of power by selecting the current cost of power from among two or more costs of power from two or more respective power providers.

Embodiment 21. A system for producing hydrogen, the system comprising: one or more electrolyzers configured to receive power and to produce hydrogen; and a controller configured to: obtain a current cost of power; obtain a predicted cost of power; obtain a current value of hydrogen; obtain a predicted value of hydrogen; determine a rate for an electrolyzer to produce hydrogen based on the current cost of power, the predicted cost of power, the current value of hydrogen, and the predicted value of hydrogen; control operations of the electrolyzer such that the electrolyzer produces hydrogen at substantially the determined rate; determine to store a first amount of hydrogen based on the current cost of power, the predicted cost of power, the current value of hydrogen, and the predicted value of hydrogen; direct the first amount of hydrogen to a hydrogen storage; determine to remove a second amount of hydrogen from the hydrogen storage based on the current cost of power, the predicted cost of power, the current value of hydrogen, and/or the predicted value of hydrogen; and direct the second amount of hydrogen from the hydrogen storage.

Embodiment 22. A non-transitory computer-readable storage medium having stored thereon instructions that, when executed by at least one processor, cause the at least one processor to perform operations according to any of embodiments 1 to 13.

Embodiment 23. An apparatus for providing virtual content for display, the apparatus comprising one or more means for perform operations according to any of embodiments 1 to 13.

What is claimed is:

1. A method for producing hydrogen, the method comprising:
obtaining a current cost of power;
obtaining historical power-cost data indicative of historical costs of power;
determining a predicted cost of power based on the historical power-cost data;
obtaining a request for hydrogen;
determining a current value of hydrogen based on the request for hydrogen;
obtaining historical hydrogen-value data indicative of historical values of hydrogen;
determining a predicted value of hydrogen based on the historical hydrogen-value data;
determining a rate for an electrolyzer to produce hydrogen based on the current cost of power, the predicted cost of power, the current value of hydrogen, and the predicted value of hydrogen; and
controlling operations of the electrolyzer such that the electrolyzer produces hydrogen at substantially the determined rate.

2. The method of claim 1, further comprising determining an amount of hydrogen to store based on the current value of hydrogen and the predicted value of hydrogen.

3. The method of claim 2, further comprising determining a storage capacity of a hydrogen storage.

4. The method of claim 2, further comprising directing the amount of hydrogen to a hydrogen storage.

5. The method of claim 1, further comprising determining an amount of hydrogen to remove from a hydrogen storage based on the current value of hydrogen and the predicted value of hydrogen.

6. The method of claim 1, further comprising determining an amount of hydrogen to store based on the current cost of power and the predicted cost of power.

7. The method of claim 6, further comprising determining a storage capacity of a hydrogen storage.

8. The method of claim 6, further comprising directing the amount of hydrogen to a hydrogen storage.

9. The method of claim 1, further comprising determining an amount of hydrogen to remove from a hydrogen storage based on the current cost of power and the predicted cost of power.

10. The method of claim 1, further comprising obtaining a priority request for hydrogen, wherein determining the rate for the electrolyzer to produce hydrogen is further based on the priority request for hydrogen.

11. The method of claim 1, wherein obtaining the current cost of power comprises selecting the current cost of power from among two or more costs of power from two or more respective power providers.

12. The method of claim 1, further comprising obtaining a current cost of water, wherein determining the rate for the electrolyzer to produce hydrogen is further based on the current cost of water.

13. A method for producing hydrogen, the method comprising:
obtaining a current cost of power;
obtaining a predicted cost of power;
obtaining a current value of hydrogen;
obtaining a predicted value of hydrogen;
determining a rate for an electrolyzer to produce hydrogen based on the current cost of power, the predicted cost of power, the current value of hydrogen, and the predicted value of hydrogen;
controlling operations of the electrolyzer such that the electrolyzer produces hydrogen at substantially the determined rate;
determining to store a first amount of hydrogen based on the current cost of power, the predicted cost of power, the current value of hydrogen, and the predicted value of hydrogen;
directing the first amount of hydrogen to a hydrogen storage;
determining to remove a second amount of hydrogen from the hydrogen storage based on the current cost of power, the predicted cost of power, the current value of hydrogen, and/or the predicted value of hydrogen; and
directing the second amount of hydrogen from the hydrogen storage.

14. A system for producing hydrogen, the system comprising:
one or more electrolyzers configured to receive power and to produce hydrogen; and
a controller configured to:
obtain a current cost of the power;
obtain historical power-cost data indicative of historical costs of power;
determine a predicted cost of power based on the historical power-cost data;
obtain a request for hydrogen;
determine a current value of hydrogen based on the request for hydrogen;
obtain historical hydrogen-value data indicative of historical values of hydrogen;
determine a predicted value of hydrogen based on the historical hydrogen-value data;
determine a rate for the one or more electrolyzers to produce hydrogen based on the current cost of power, the predicted cost of power, the current value of hydrogen, and the predicted value of hydrogen; and
control operations of the one or more electrolyzers such that the one or more electrolyzers produces hydrogen at substantially the determined rate.

15. The system of claim 14, wherein the controller is further configured to determine an amount of hydrogen to store based on the current value of hydrogen, the predicted value of hydrogen, the current cost of power, and the predicted cost of power.

16. The system of claim 15, wherein the controller is further configured to determine a storage capacity of a hydrogen storage.

17. The system of claim 15, wherein the controller is further configured to direct the amount of hydrogen to a hydrogen storage.

18. The system of claim 15, wherein the controller is further configured to determine an amount of hydrogen to remove from a hydrogen storage based on the current value of hydrogen and the predicted value of hydrogen.

19. The system of claim 14, wherein the controller is further configured to obtain a priority request for hydrogen and wherein the controller is further configured to determine the rate for the one or more electrolyzers to produce hydrogen further based on the priority request for hydrogen.

20. The system of claim 14, wherein the controller is further configured to obtain the current cost of power by selecting the current cost of power from among two or more costs of power from two or more respective power providers.
